(19) United States
(12) Patent Application Publication
(10) Pub. No.: US 2002/0057650 A1
(43) Pub. Date: May 16, 2002

(54) TRAFFIC SHAPING FOR FRAME AND IP PACKETS IN AN ENTERPRISE SWITCH

(76) Inventors: MOOI CHOO CHUAH, EATONTOWN, NJ (US); RAMESH NAGARAJAN, MONMOUTH, NJ (US)

Correspondence Address: KEITH D. NOWAK, ESQ., LIEBERMAN & NOWAK, LLP, 350 FIFTH AVENUE, 74TH FLOOR, NEW YORK, NY, 10118, US

(21) Appl. No.: 08/934,950

(22) Filed: Sep. 22, 1997

Related U.S. Application Data
(60) Provisional application No. 60/040,249, filed on Feb. 11, 1997.

(51) Int. Cl. H04L 1/00

(52) U.S. Cl. 370/232; 370/474

(57) ABSTRACT

An ATM switch for directing traffic flow of native ATM cell traffic and frame based packets between an input and an output port of the switch comprises a device for receiving native ATM cells and transporting the native ATM cells to the output port for output at a switch output rate; a device for receiving the frame based packets; a device for segmenting each received frame based packet into a corresponding plurality of ATM cells and transmitting the plurality of ATM cells to the output port at an ATM cell transmission rate; and a control device for controlling the ATM cell transmission rate to enable reduction of ATM cell loss at the output port and corresponding frame relay packet loss at the expense of packet delay.

### RELATED APPLICATIONS

This application claims the benefit of provisional U.S. Patent Application Serial No. 60/040,249 filed Feb. 11, 1997.

### FIELD OF THE INVENTION

The present invention relates generally to packet-switching communication systems, e.g., ATM (Asynchronous Transfer Mode), and particularly, to schemes for shaping traffic in ATM and packet data switches.

### BACKGROUND OF THE INVENTION

ATM switches are beginning to make an appearance in service provider's networks. However, the networking technology of choice for end-users remains packet-switching technology, including, for example, IP/Frame relay (FR) packets, IPX and ATM FUNI, and TCP (UDP)/IP(IP) among others due to the slow penetration of native ATM to desktops. This implies that enterprise switches in the near future will need to provide FR and IP interfaces on the premises side and ATM connectivity on the wide-area network (WAN) side.

FIG. 1 illustrates an enterprise switch 10 with IP packet or frame relay traffic 20 being multiplexed with native ATM traffic 25 onto a wide-area links. Particularly, at the FR/IP interface card 22, a segmentation process is performed in the ATM adaption layer (AAL) whereby IP and/or frame relay (FR) packets (collectively “Packets”) are converted to ATM cells. Particularly, as shown in FIGS. 2(a) and 2(b) the segmentation process involves converting FR packets 20a, b, c into corresponding one or more ATM cells 30a, b, c, respectively, in accordance with well known SAR (segmentation and reassembly) techniques. In such a configuration, for example, a 1500 byte FR Packet generates 30 ATM cells, instantaneously, with each ATM cell having about 53 bytes. As shown in FIG. 1, these ATM cells are transported through the ATM switch fabric 32 at the switch port rate to the egress port queue 35 of ATM output card 40. Since the switch port speed can be orders of magnitude larger than the egress port rate, the ATM cells 30 arrive at a very high rate relative to the port queue service rate. That is, the instantaneous rate of arrival of ATM cells at the egress port queue 35 is substantially greater than the output speed at the wide-area WAN egress link 50, e.g., a T-1 link, resulting in queue buildup and cell losses which have a serious performance impact on the ATM and non-ATM traffic. For example, there may be difficulties in meeting the cell loss and other Quality-Of-Service (QoS) guarantees for the ATM services, and large Packet losses for the non-ATM traffic since single ATM cell losses cause loss of entire packets. While one could account for this high-rate burst in the ATM connection admission control (CAC) mechanism, it would be prohibitively expensive in terms of the bandwidth required to prevent e.g., cell loss.

It would thus be desirable to shape the ATM cells resulting from the segmentation of packets in order to smooth the ATM cell bursts at the switch outputs and reduce their congestion impact.

### SUMMARY OF THE INVENTION

The invention is a packet traffic shaping scheme for one or more streams of packet traffic sharing a common resource, e.g., an output egress link in a packet switching device. A first stream of delay tolerant packets, e.g. IP/frame-based packets, are multiplexed to a second stream of packets, e.g. native ATM cells having to meet QoS guarantees. Particularly, the invention provides for the dynamic shaping of the first stream of traffic that is effective in limiting the FR and IP packet loss and the ATM cell loss at the expense of some additional delays for FR and IP traffic which additional delays are acceptable for the packet traffic.

One aspect of the invention is to provide, in an ATM interface switch, an open-loop shaping scheme that shapes traffic “constantly” regardless of the congestion on the WAN egress link. Another aspect of the invention is a closed-loop shaping scheme whereby the FR and IP traffic is shaped only when there is congestion on the egress hnk. This closed-loop scheme provides superior performance to the first since shaping only takes place when it is needed.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF DRAWINGS

FIG. 1 is a general diagram illustrating an ATM switch capable of multiplexing native ATM cell and IP/FR data.

FIG. 2 is a diagram illustrating segmentation of IP and/or FR Packets data into ATM cells.

FIG. 3(a) illustrates a traffic shaping scheme of the first embodiment of the invention.

FIG. 3(b) illustrates a variation of the traffic shaping scheme of the first embodiment of the invention.

FIG. 4 illustrates the circuit implementation of a traffic shaping scheme of the second embodiment of the invention.

FIG. 5 illustrates ATM cell traffic transmission as governed by the shaping scheme of the second embodiment of the invention.

FIG. 6 illustrates a variation of egress buffer queue thresholding technique implemented by the shaping scheme of the second embodiment of the invention.

FIG. 7(a) illustrates a plot of Stop/Go shaping loss rates versus stop thresholds.

FIG. 7(b) illustrates a plot of Frame delay versus stop thresholds.

FIG. 8(a) illustrates a plot of shaping method performance impact on FR packet loss rates.

FIG. 8(b) illustrates a plot of shaping method performance impact on FR delay.

FIG. 9 illustrates a plot of the ATM Cell loss rate for different shaping methods.

### DETAILED DESCRIPTION OF THE INVENTION

As packet traffic does not have any binding QoS guarantees, or, have only loosely defined QoS guarantees, this traffic is shaped to reduce the performance impact of large high-rate bursts. This shaping implies that ATM and non-ATM cell loss could be reduced at the expense of some additional delays for the packet traffic.

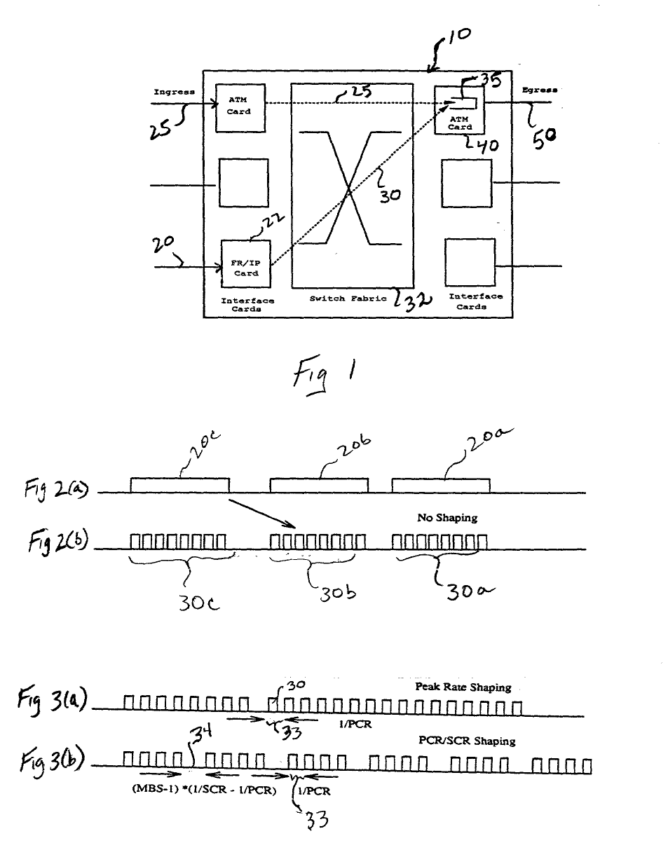

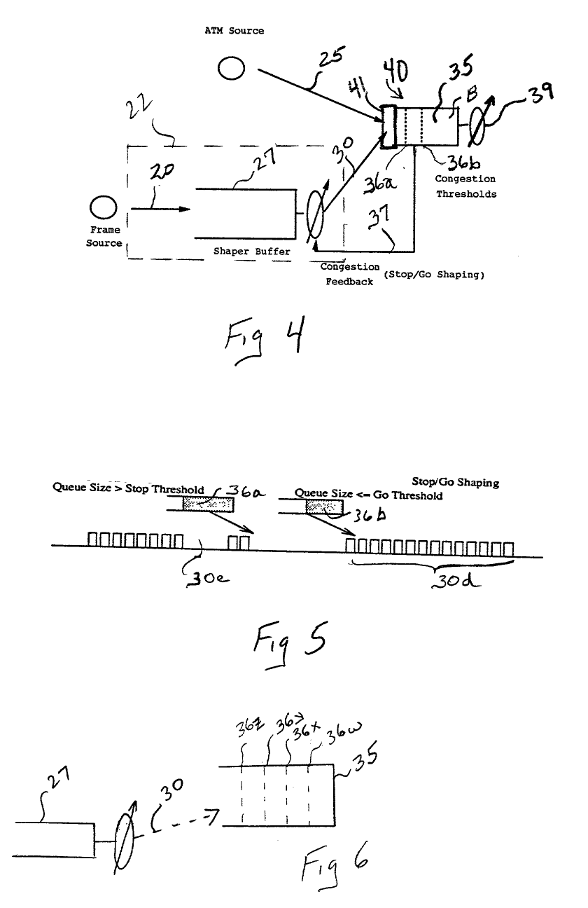

FIG. 3(a) illustrates the result of an open-loop ATM traffic shaping scheme that is blind to congestion on the WAN egress link. In this embodiment, SAR mechanisms are implemented at the FR/IP Interface card 22 (FIG. 1) to shape the output ATM cell traffic to conform to a given peak cell-rate (PCR), i.e., just enforce a minimum spacing between output ATM cells. Thus, as shown in FIG. 3(a) ATM cells 30 are output with a spacing of 1/PCR and may be implemented by commercially available SAR (segmentation and reassembly) chips, e.g., the Bt8230 provided by provided by Brooktree Corp. As is known, such SAR chips are already employed in ATM cell rate policing, e.g., the so-called “leaky bucket” policing.

In accordance with the principles of the invention, a variation of the first embodiment is an open-loop ATM traffic shaping scheme that shapes ATM cell traffic to conform to a given peak cell-rate (PCR) and sustainable cell-rate (SCR). The PCR/SCR shaping imposes two restrictions on the cell stream arising from the segmentation of the packet traffic. First, it enforces a minimum spacing between the ATM cells proportional to the inverse of the PCR, and second, it ensures that the number of cells departing the shaper in any time unit “t”, denoted as D(t), always obeys the following relation:

D(t)≦SCR t+MBS, ∀t>0,

where MBS denotes the maximum burst-size beyond the SCR. FIG. 3(b) illustrates the ATM traffic output of the FR and IP interface card in accordance with the SCR/PCR shaping scheme with a minimum spacing 33 between ATM cells denoted as 1/PCR, and a minimum spacing 34 between groups of ATM cells in accordance with the relation (MBS−1)*(1/SCR−1/PCR). As mentioned above, this shaping may also be implemented by commercially available SAR (segmentation and reassembly) chips.

A second scheme, referred to as Stop/Go Shaping, shapes the packet traffic only when there is congestion at the egress ATM queue. As shown in the detailed illustration of the ATM switch in FIG. 4, congestion at the egress port 40 is detected based on a first “stop” threshold 36a on the queue occupancy at the egress queue 35 which information is signaled back to the shaper buffer 27 located at the FR/IP Packet interface card 22 either via a hardwire connection, an built-in backpressure mechanism (not shown) or, preferably, a special virtual circuit, e.g., VC 37 setup within the switch. Shaping in this closed-loop scheme is simplistic in that the cell stream 30 derived from the Packet shaper buffer 27 is turned off, i.e., no ATM cells are allowed to leave the shaper, when congestion is detected at the egress queue 35, and, is turned on again, i.e., ATM cells are allowed to leave the shaper, when the congestion subsides. As shown in FIG. 4, the abatement of congestion is detected based on a second “go” threshold 36b on queue occupancy that is lower than the first threshold. Preferably, the first stop threshold 36a is set near the memory limit of the egress queue 35 and the go queue occupancy threshold 36b is set to provide a hysteresis in order to avoid queue oscillations about the single first threshold level. As in the first embodiment, SAR chips may be employed to shape, in accordance to the feedback, the ATM cell traffic in the second embodiment.

FIG. 5 illustrates the stop/go shaping scheme of the preferred embodiment whereby cells 30d are transported to the egress buffer 35 at the switch port speed when the queue occupancy threshold is greater than the “go” threshold 36b. As shown in FIG. 5, when the queue occupancy threshold is determined to be greater than the “stop” threshold 36a, the traffic of ATM cells 30e is stopped from being transported to the egress buffer.

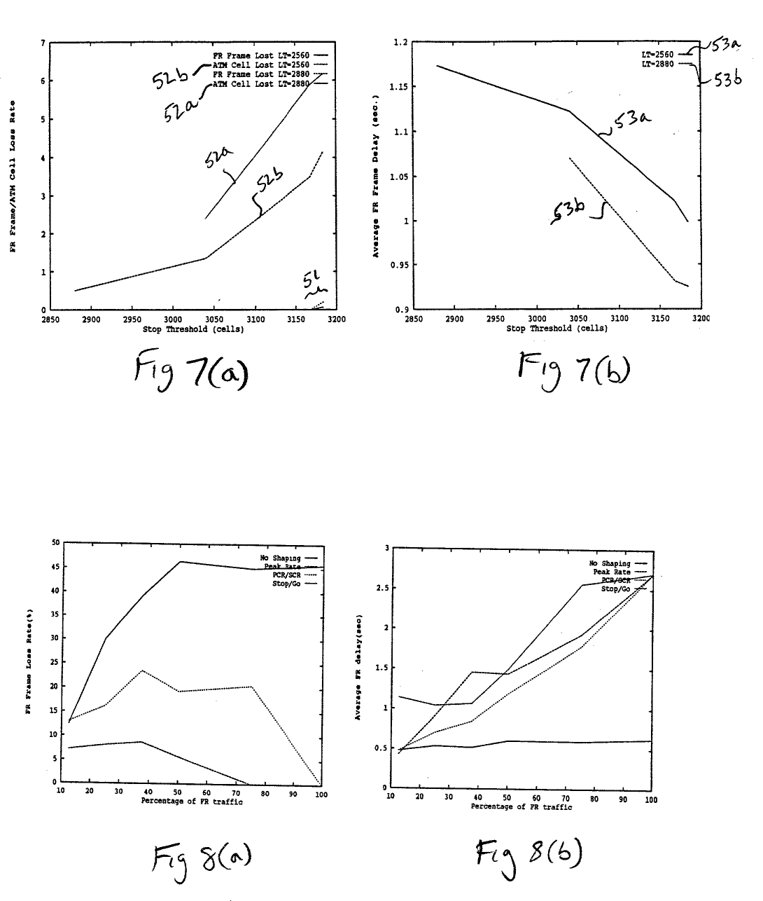

It should be understood that instead of completely stopping transmission of the ATM traffic upon detection of congestion, transmission rate of segmented ATM cells 30 may be drastically reduced to a point where congestion at the egress buffer is avoided. Alternatively, in accordance with the principles of the invention, the stop/go ATM cell traffic shaping scheme of the preferred embodiment may be implemented by establishing multiple egress queue occupancy thresholds, e.g., three or more thresholds, to enable finer control of the performance. For instance, as shown in FIG. 6, egress queue 35 may have a first stop threshold 36x enabling the ATM cell stream 30 to be transported from the shaper buffer 27 at a first reduced rate PCR₁, for example, and, an additional stop threshold 36z enabling the ATM cell stream 30 to be transported from the shaper buffer 27 at a second reduced rate PCR₂, whereby PCR₁>PCR₂. Of course, the PCR₂ may be set to zero, to completely stop traffic flow when egress queue congestion is detected. It should be understood that, in this case, associated with stop threshold 36x is go threshold 36w, and associated with stop threshold 36z is go threshold 36y.

When egress queue length drops below go threshold 36y after it has exceeded stop threshold 36z, the output rate will switch from PCR₂ to PCR₁. Later, if the egress queue length continues to drop below go threshold 36w, then the output rate is switched back to PCR. Note that a three threshold scheme can be defined to achieve the same purpose.

For a given shaping scheme, performance metrics such as Frame Relay (FR) Packet loss rate and average delay (for packet traffic) and ATM cell loss, were evaluated using the queueing model, such as illustrated in FIG. 4, and choosing suitable simulation values for traffic parameters. It should be understood that a FR packet is considered lost when any of the cells constituting the packet is lost. As shown in FIG. 4, native ATM cell traffic 25 and ATM cells 30 generated from the Packet traffic compete for bandwidth and buffer space at the egress port queue 35 shown in the Figure as an ATM multiplexer 41 having a completely shared buffer of size B cells and implementing, for example, a first-come,first-served (FCFS) service discipline 39. The cell transmission time at the multiplexer 41 is taken to be the unit of time. Both the packet source 30 and the native ATM source 25 are assumed to alternate between transmission (ON) and silent (OFF) periods according to, e.g., a 2-state Markov chain. When a source is ON, it is assumed to generate deterministically-spaced packets (cells) at time units of Tₒₙ such as shown in FIG. 5. The number of packets (cells) in the ON period is taken to be geometrically distributed with mean Pₒₙ. The length of the packet (cell) is taken to be a fixed L. The peak rate of the source is then given as p=L/Tₒₙ and the mean rate m=p/b, where b denotes the burstiness of the source.

A simulation of the stop/go shaping method was conducted with the following traffic parameters: Frame relay packets size was fixed at L=1528 bytes with a Tₒₙ, set to 16, Pₒₙ set to 100, and b set to 6.667; ATM cell size was 53 bytes, Pₒₙ set to 100, and b set to 6.667 values. The value of the Tₒₙ, for ATM cell traffic was varied to keep the total load fixed at 80% of available bandwidth. In evaluating the performance of the stop/go shaping method, the FR frame traffic amounted to about 30% of the total traffic with the remaining traffic being native ATM cell traffic. For the simulation, it was assumed that the FR and ATM sources compete for a buffer space B equal to, e.g., 3200 cells at the ATM multiplexer. For purposes of the delay computations, a T1 link is assumed, with the time for an ATM cell to be transmitted onto the link to be about 0.27 milliseconds and taken as unit time. Note, that in the stop/go simulation, there is a delay involved in signaling the congestion at the egress queue 35 to the interface card 22 which is taken to be equal to unit time.

In order to study the impacts of the stop/go thresholds on the FR and ATM cell losses for the Stop/Go Shaping method, the peak rate is fixed (same as no shaping rate) and the FR traffic is transmitted into the ATM multiplexer 41 with the Stop and Go thresholds varied. FIG. 7(a) illustrates the FR and ATM cell loss rate (y-axis) versus the queue occupancy stop threshold (x-axis) and, FIG. 7(b) illustrates a plot of the average FR frame delay versus the queue occupancy stop threshold (x-axis), for the Stop/Go Shaping method. As indicated by lines 5, it can be seen that the FR loss is relatively unaffected by the choice of the stop threshold at the egress queue 35 because the loss can be completely controlled as long as the room between the Stop threshold and the egress buffer limit is sufficient to accommodate any ATM cells 30 in transit from the FR interface card 22 to the egress ATM card 40 before the congestion indication reaches the interface card 22. For the considered parameter settings, this value is 16 cells which is generally small since the switching delay within a switch is typically small, e.g., in the order of microseconds, and hence the number of cells in transit is small. Hence, no loss occurs till the Stop threshold exceeds, e.g., 3184 for a buffer of size 3200, indicated in FIG. 7(a).

As for the ATM cell loss both the Stop and Go thresholds have an impact. As shown in FIG. 7(a), as both the Stop and Go thresholds increase, as indicated by lines 52a, and 52b, the ATM cell loss increases. Hence, smaller values of these thresholds are desirable. However, from a FR delay standpoint, higher values of the thresholds are desired as indicated by FR frame delay lines 53a and 53b plotted in FIG. 7(a). As seen in the FIG. 7(b) the relative impact of the thresholds on the delay is small however, and hence a value of the Stop threshold that is close to the value necessary to prevent frame loss, e.g., 3184, and the Go threshold to be small, e.g., 2560 may be chosen.

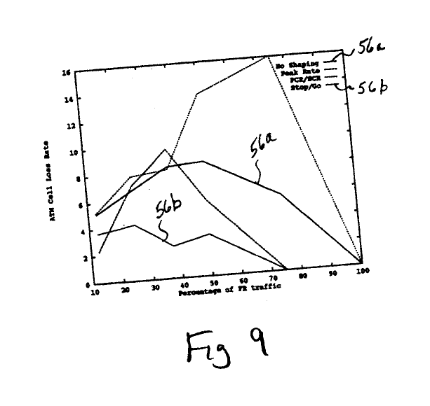

FIG. 8(a) illustrates a plot of the FR Packet loss (y-axis) for different percentages of FR traffic (x-axis) for each of the different shaping methods and the no-shaping case, and FIG. 8(b) illustrates a plot of the average FR frame delay in seconds (y-axis) for different percentages of FR traffic (x-axis) for each of the different shaping methods and the no-shaping case. FIG. 9 illustrates a plot of the ATM cell loss rate (y-axis) for different percentages of FR traffic (x-axis) for each of the different shaping methods and the no-shaping case. It can be seen that all of the shaping schemes dramatically reduce the FR loss with the PCR/SCR and the Peak Rate shaping schemes reducing the packet loss from about 15-45% for the no-shaping case to about 5-25% and the packet loss for the Stop/Go scheme being zero. This reduced FR loss is clearly achieved at the expense of some additional delays in all the schemes. For instance, with an equal mix of FR and ATM traffic, the delay is roughly doubled over the no-shaping case to about 1 sec. from 0.5 sec. Finally, the ATM cell loss for the PCR scheme is comparable to no-shaping case in general, but considerably improved in some cases. It is, however, almost uniformly worse for the PCR/SCR scheme, compared to the no-shaping case, probably due to a non-optimal choice of parameters, for this scheme. As shown in FIG. 9, the Stop/Go scheme results in reducing the ATM cell loss from about 0-8% as indicated by line 56a (no-shaping scheme) to the range of 0-4% as indicated by line 56b.

As shown in FIG. 9, the Stop/Go shaping scheme is extremely effective in limiting the FR and ATM cell loss at the expense of some additional delays for FR traffic. Further, the choice of “optimal” parameters for this scheme is extremely simple and result in predictable and uniformly superior performance.

The foregoing merely illustrates the principles of the present invention. Those skilled in the art will be able to devise various modifications, which although not explicitly described or shown herein, embody the principles of the invention and are thus within its spirit and scope.

What is claimed is:

1. An ATM switch for directing traffic flow of native ATM cell traffic and packet traffic, said ATM switch comprising:
first input means for receiving native ATM cells and transporting said native ATM cells to an output port for output at an output port rate;
second input means for receiving said frame based packets;
means for segmenting each received frame based packet into a corresponding plurality of ATM cells and transmitting said plurality of ATM cells to said output port at an ATM cell transmission rate; and,
means for controlling said ATM cell transmission rate to enable reduction of native and ATM cell loss at said output port and reduction of corresponding frame based packet loss at the expense of packet delay.

2. An ATM switch as claimed in claim 1, whereby said output port includes a queue means for receiving ATM traffic including both said native ATM cells and said plurality of ATM cells prior to output, said means for controlling said ATM cell transmission rate comprising:
means for detecting amount of ATM traffic on said output queue; and
feedback means for communicating said detected amount of ATM traffic to said segmenting means and changing said ATM cell transmission rate in accordance with the detection of ATM traffic congestion.

3. An ATM switch as claimed in claim 2, whereby said means for detecting said amount of ATM traffic includes detecting when a number of ATM traffic cells at said output queue reach a predetermined threshold.

4. An ATM switch as claimed in claim 3, whereby said transmission cell rate is reduced when a number of ATM cells at said output queue reach a first said predetermined threshold.

5. An ATM switch as claimed in claim 4, whereby said transmission cell rate is increased when a number of ATM cells at said output queue drop to a second predetermined threshold, said first predetermined threshold being larger than said second predetermined threshold.

6. An ATM switch as claimed in claim 2, wherein said transmission cell rate is reduced to zero when a number of ATM cells at said output queue reach said predetermined threshold.

7. An ATM switch as claimed in claim 1, wherein said ATM transmission cell rate is controlled to be equal to or less than a peak output port rate.

8. An ATM switch as claimed in claim 1, wherein said ATM transmission cell rate is greater than said output port rate.

9. An ATM switch as claimed in claim 1, wherein said output port includes multiplexer means for receiving said native ATM cells and said plurality of ATM cells and placing said received native ATM cells and said plurality of ATM cells on said queue.

10. An ATM switch as claimed in claim 1, wherein said frame based packets includes IP/Frame Relay packets.

11. An ATM switch as claimed in claim 1, wherein said frame based packets includes IPX packets.

12. An ATM switch as claimed in claim 1, wherein said frame based packets includes ATM FUNI packets.

13. Method for directing traffic flow of native ATM cell traffic and frame based packets between an input and an output port of the switch, said method comprising:
receiving native ATM cells and transporting said native ATM cells to said output port, said native ATM cells exiting said output port at an output port rate;
receiving said frame based packets;
segmenting each received frame based packet into a corresponding plurality of ATM cells and transmitting said plurality of ATM cells to said output port at an ATM cell transmission rate; and,
controlling said ATM cell transmission rate to enable reduction of native and plurality of ATM cell loss at said output port and reduction of corresponding packet loss at the expense of packet delay.

14. Method for directing traffic flow as claimed in claim 1, wherein said output port includes a queue means for receiving ATM traffic including both said native ATM cells and said plurality of ATM cells, said controlling step including the steps of detecting an amount of ATM traffic on said output queue; and changing ATM cell transmission rate in accordance with the detection of ATM traffic at said output queue.

15. Apparatus for shaping traffic flow in a packet switching device having a first input receiving a first packet stream, and a second input receiving a second packet stream, the packets of said first packet stream being more delay tolerant than packets of said second data stream, and both said first and second packet streams being multiplexed to a common output of said device, said apparatus comprising:
a control device at said second input for transmitting received packets of said second data stream, said packets of said second data stream being transmitted at a packet transmission rate suitable for reducing packet loss of both said first and second packet streams, thereby improving performance at the expense of packet delay of packets of said second stream.

16. Apparatus for shaping traffic flow in a packet switching device as claimed in claim 15, wherein packets of said first stream are frame based packets and said second packets are native ATM cells, said control device comprising means for segmenting said frame based packets into a corresponding plurality of ATM cells, and transmitting said plurality of ATM cells to said output port at an ATM cell transmission rate.

17. Apparatus for shaping traffic flow in a packet switching device as claimed in claim 16, wherein said ATM cell transmission rate at said second input is greater than an output ATM cell transmission rate at said output.

18. Apparatus for shaping traffic flow in a packet switching device as claimed in claim 16, wherein said switching device includes an output queue for temporarily storing ATM cells from said first packet stream and transmitted from said control device at said first input, said apparatus further comprising:
means for detecting amount of ATM traffic on said output queue; and
feedback means for communicating said detected amount of ATM cells to said control device and changing said ATM cell transmission rate in accordance with the amount of ATM cells stored at said output queue.

19. Apparatus for shaping traffic flow in a packet switching device having a first input receiving a first packet stream, and a second input receiving a second packet stream, the packets of said first packet stream being more delay tolerant than packets of said second data stream, and both said first and second packet streams being multiplexed to a common output of said device, said apparatus comprising:
a control device at said second input for transmitting received packets of said second data stream, said packets of said second data stream being transmitted at a packet transmission rate suitable increasing traffic load of packets of said second data stream at said common output at the expense of delay of packets of said second data stream.
